(19) United States
(12) Patent Application Publication
(10) Pub. No.: US 2022/0358393 A1
(43) Pub. Date: Nov. 10, 2022

(54) QUANTUM COMPUTER SYSTEM AND METHOD FOR PERFORMING QUANTUM COMPUTATION WITH REDUCED CIRCUIT DEPTH

(71) Applicant: Zapata Computing, Inc., Boston, MA (US)

(72) Inventors: Eric R. Anschuetz, Cambridge, MA (US); Yudong Cao, Cambridge, MA (US)

(21) Appl. No.: 17/640,633

(22) PCT Filed: Sep. 16, 2020
(86) PCT No.: PCT/US2020/051115

§ 371 Date: Mar. 4, 2022

Related U.S. Application Data
(60) Provisional application No. 62/901,045, filed on Sep. 16, 2019.

(51) Int. Cl. G06N 10/20; G06N 10/80

(52) U.S. Cl. CPC G06N 10/20; G06N 10/80

(57) ABSTRACT

A hybrid quantum-classical computer performs a method which includes converting the output of an initial quantum circuit to a target state of a physical system. A new parametrized quantum circuit, or ansatz, is then generated with the ability to produce a state approximating the target state of the physical system. The parameters of the quantum circuit are adjusted to produce the target state, or to an approximation thereof.

### BACKGROUND

Quantum computers promise to solve industry-critical problems which are otherwise unsolvable or only very inefficiently addressable using classical computers. Key application areas include chemistry and materials, bioscience and bioinformatics, logistics, and finance. Interest in quantum computing has recently surged, in part due to a wave of advances in the performance of ready-to-use quantum computers.

Many applications of quantum computers require deep quantum circuits, and thus low noise rates in the quantum computer, which may not be realizable for many years.

It is known that quantum computation can be encoded in the ground state of physical systems, often trading the depth of the quantum computation with the number of qubits needed to perform the quantum computation. However, adiabatically preparing the ground state of these physical systems often requires long coherence times and is impractical on near-term quantum devices.

### SUMMARY

Embodiments of the present invention are directed to a hybrid classical quantum computer (HQC) with the capability to increase the accuracy of a quantum computation. The method comprises converting the output of an initial quantum circuit to a target state of a physical system. A new parametrized quantum circuit, or ansatz, is then generated with the capability to produce a state approximating the target state of the physical system. The parameters of the quantum circuit can then be adjusted to produce the target state, or to an approximation thereof

Other features and advantages of various aspects and embodiments of the present invention will become apparent from the following description and from the claims.

### BRIEF DESCRIPTION OF THE DRAWINGS

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention;

FIG. 4 is a dataflow diagram of a system for performing a method implemented according to one embodiment of the present invention; and

FIG. 5 is a flowchart of a method performed by one embodiment of the present invention.

### DETAILED DESCRIPTION

Embodiments of the present invention are directed to a hybrid classical quantum computer (HQC) with the capability to increase the accuracy of a quantum computation. Many applications of quantum computers require deep quantum circuits, and thus low noise rates in the quantum computer, which may not be realizable for many years. In contrast, embodiments of the present invention do not require deep quantum circuits or low noise rates in the quantum computer. For example, embodiments of the present invention may be implemented on quantum computers using quantum circuits with a circuit depth of at most 4. As another example, embodiments of the present invention may be implemented on quantum computers having noise rates which are greater than 0.001. As a result, embodiments of the present invention may be implemented on near-term quantum computers.

It is known that quantum computation can be encoded in the ground state of physical systems, often trading off the depth of the quantum computation against the number of qubits needed to perform the quantum computation. However, adiabatically preparing the ground state of these physical systems often requires long coherence times and is impractical on near-term quantum devices, which only have coherence times on the order of tens of microseconds.

Embodiments of the present invention thus present a means by which a digital quantum computer can trade one resource for another. By converting the output of a first quantum circuit to the target state or ground state of a physical system, additional qubit overhead may be introduced into the circuit. However, the target state of this system may be achieved more quickly (i.e. with a lower circuit depth) than the first quantum circuit, for instance, by using a variational quantum eigensolver to train a circuit ansatz to reach the target state. Thus, quantum computers with many physical qubits but which suffer from low coherence times or high gate errors may thus utilize embodiments of the present invention to produce a more accurate computation.

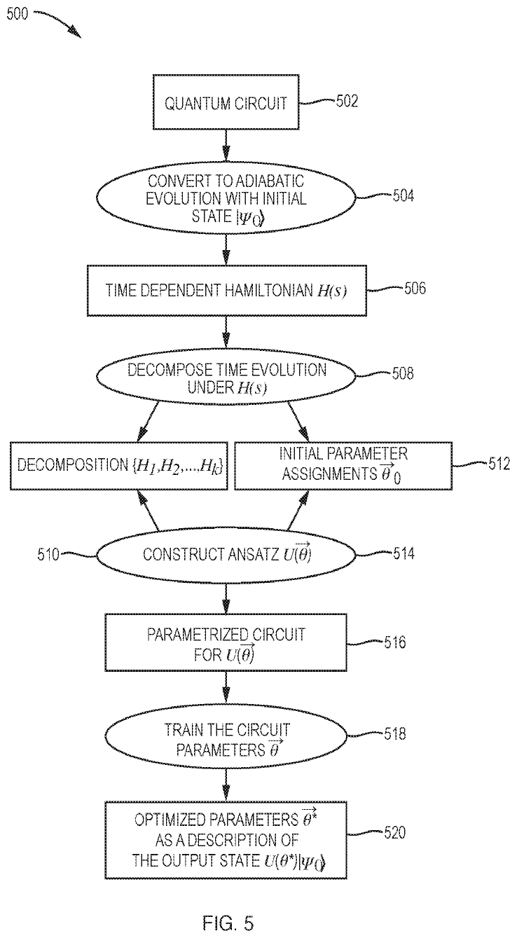

Embodiments of the present invention are directed to a method of executing quantum computation on a hybrid quantum-classical computer, the hybrid quantum-classical computer comprising a classical computer and a quantum computer. The method comprises converting the output of an initial quantum circuit to a target state of a physical system. A new parametrized quantum circuit, or ansatz, is then generated with the capability to produce a state approximating the target state of the physical system. The parameters of the quantum circuit can then be adjusted to produce the target state, or to an approximation thereof. Referring to FIG. 5, a flowchart is shown of a method 500 performed by a hybrid quantum-classical (HQC) computer according to one embodiment of the present invention. The HQC computer includes both a classical computer and a quantum computer. The classical computer generates a description of a quantum circuit 502, which is implemented on the quantum computer. The quantum computer converts the quantum circuit 502 into an equivalent time-dependent quantum computation 504 (which may, for example, be adiabatic), which the quantum computer in turn translates into an equivalent evolution under a time-dependent Hamiltonian 506.

The classical computer decomposes 508 the input time-dependent Hamiltonian 506 into a sequence of Hamiltonian evolutions 510 implementable on the quantum computer with a known parameterization 512 given the decomposition. In some embodiments, this is the Trotterization of the evolution.

The sequence of Hamiltonian evolutions 110 specified on the classical computer in series defines an ansatz circuit 514, with the initial parameters given by the known parameterization of the decomposition 512. This completely describes a parameterized ansatz circuit 516, where said description is stored on the classical computer.

Given the parameterized ansatz circuit 516 as input, the classical computer trains 518 the parameters of the ansatz circuit on the quantum computer. The training procedure consists of making measurements on the quantum computer and the classical computer proposing a new set of parameters for the ansatz circuit given these measurement outcomes such that the expectation value of the space-time Hamiltonian is minimized. In some embodiments, the new set of parameters is generated through a gradient-based optimization algorithm on the classical computer, where the objective function is the energy.

The classical computer outputs the optimized parameters of the ansatz circuit 520, along with the ansatz circuit, such that when the ansatz circuit with the optimized parameters are run on the quantum computer they approximate the output of the input quantum circuit. The quantum computer in the HQC computer may execute the ansatz circuit.

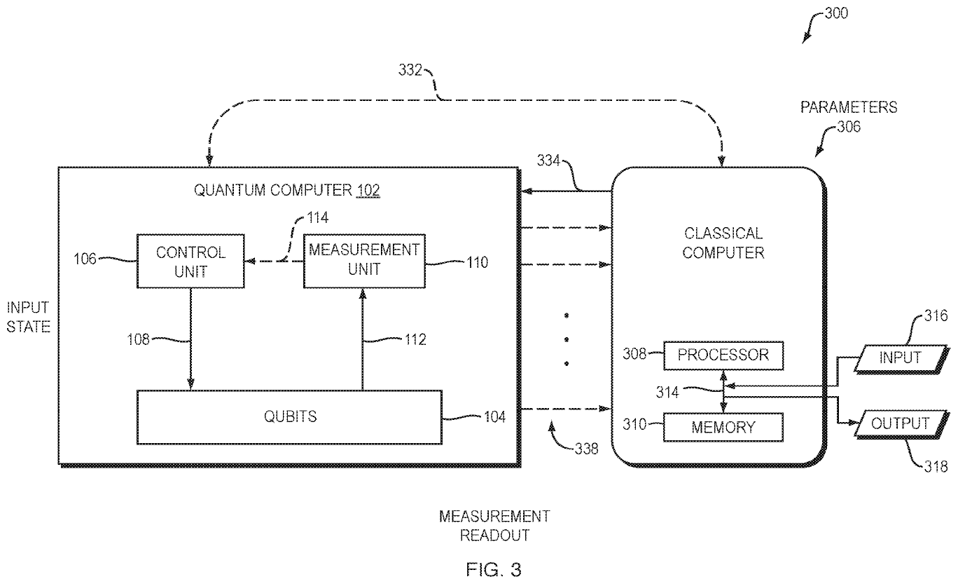

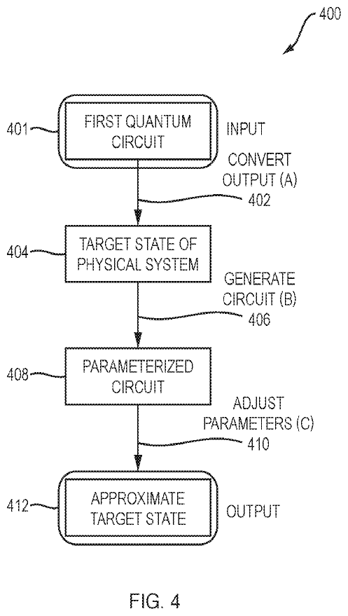

Referring to FIG. 4, a dataflow diagram is shown of a system 400 which may perform a method according to one embodiment of the present invention. The system 400 may, for example, include a hybrid-quantum classical computer including a classical computer and a quantum computer, such as the hybrid quantum-classical computer 300 of FIG. 3, which may perform the method disclosed herein in connection with FIG. 4.

The system includes, and receives as input, a description 401 of a first quantum circuit. The classical computer in the system 400: (A) converts 402 the description 401 of the first quantum circuit to a description 404 of a target state of a physical system. The physical system may, for example, include interacting spins occupying a two-dimensional lattice.

The classical computer in the system 400: (B) generates 406 a description 408 of a parametrized circuit having a plurality of parameters with a plurality of initial values.

The hybrid quantum-classical computer 400: (C) adjusts 410 the plurality of initial values of the parameterized circuit to produce a plurality of adjusted values 412 in an adjusted quantum circuit, the adjusted quantum circuit being adapted to produce a quantum evolution to a state approximating the target state of the physical system. The adjusting 410 may, for example, be performed by the classical computer in the hybrid quantum-classical computer 400 and/or by the quantum computer in the hybrid quantum-classical computer 400.

The adjusted quantum circuit may be adapted to produce a quantum evolution to the target state of the physical system. Although not shown in FIG. 4, the quantum computer in the hybrid quantum-classical computer 400 may further: (D) execute the adjusted quantum circuit to produce the quantum evolution to the state approximating the target state of the physical system. Although not shown in FIG. 4, the quantum computer in the hybrid quantum-classical computer 400 may further: (E) execute the adjusted quantum circuit to produce the quantum evolution to the target state of the physical system.

Adjusting the initial values of the plurality of parameters to produce a quantum evolution may include optimizing the plurality of parameters of the parametrized circuit with respect to an objective function. Such optimizing may include: (C)(1) executing the parametrized circuit on the quantum computer; (C)(2) collecting measurement outcomes, resulting from executing the parametrized circuit, on the quantum computer; (C)(3) estimating the objective function on the classical computer using the measurement outcomes to produce an objective function estimate; and (C)(4) adjusting the plurality of initial values based on the objective function estimate. The computer 400 may repeat (C)(1)-(C)(4) until the adjusted quantum circuit is adapted to produce the quantum evolution to the state approximating the target state of the physical system.

The quantum evolution may be an adiabatic evolution, and converting the description of the quantum circuit to the description of a parametrized circuit may include: (B)(1) discretizing the adiabatic evolution into a plurality of segments of evolution under time-independent interactions; and (B)(2) defining a duration of each of the plurality of time segments as a corresponding one of the plurality of parameters, thereby defining the plurality of parameters.

Adjusting the plurality of initial values may include: (C)(1) taking a discrete Fourier transform of the plurality of initial values to produce a plurality of Fourier coefficients of the plurality of parameters; and (C)(2) adjusting the plurality of Fourier coefficients of the plurality of parameters to produce the plurality of adjusted values.

Generating the description of the parametrized circuit may include converting the description of the quantum circuit into the description of the parametrized circuit.

The hybrid quantum-classical computer may include: a classical computer comprising at least one processor and at least one non-transitory computer-readable medium having computer program instructions stored thereon; and a quantum computer comprising a plurality of qubits. The computer program instructions may be executable by the processor(s) to perform a method, such as the method disclosed above in connection with FIG. 4.

For example, the method may include: (A) on the classical computer, converting a description of a first quantum circuit to a description of a target state of a physical system; and (B) on the classical computer, generating a description of a parametrized circuit having a plurality of parameters with a plurality of initial values. The hybrid quantum-classical computer 400 may further include: (C) means for adjusting the plurality of initial values to produce a plurality of adjusted values in an adjusted quantum circuit, the adjusted quantum circuit being adapted to produce a quantum evolution to a state approximating the target state of the physical system.

The adjusted quantum circuit may be adapted to produce a quantum evolution to the target state of the physical system. In some embodiments, the classical computer includes the means for adjusting. In some embodiments, the quantum computer includes the means for adjusting.

The quantum computer may further include: (D) means for executing the adjusted quantum circuit to produce the quantum evolution to the state approximating the target state of the physical system. The quantum computer may further include: (E) means for executing the adjusted quantum circuit to produce the quantum evolution to the target state of the physical system.

The means for adjusting the initial values of the plurality of parameters to produce a quantum evolution may include means for optimizing the plurality of parameters of the parametrized circuit with respect to an objective function. The means for optimizing may include: (C)(1) means for executing the parametrized circuit on the quantum computer; (C)(2) means for collecting measurement outcomes, resulting from executing the parametrized circuit, on the quantum computer; (C)(3) means for estimating the objective function on the classical computer using the measurement outcomes to produce an objective function estimate; and (C)(4) means for adjusting the plurality of initial values based on the objective function estimate. The hybrid quantum-classical computer may further include means for repeating (C)(1)-(C)(4) until the adjusted quantum circuit is adapted to produce the quantum evolution to the state approximating the target state of the physical system.

The physical system may include interacting spins occupying a two-dimensional lattice.

The quantum evolution may include an adiabatic evolution, and converting the description of the quantum circuit to the description of a parametrized circuit may include: (B)(1) discretizing the adiabatic evolution into a plurality of segments of evolution under time-independent interactions; and (B)(2) defining a duration of each of the plurality of time segments as a corresponding one of the plurality of parameters, thereby defining the plurality of parameters.

The means for adjusting the plurality of initial values may include: (C)(1) means for taking a discrete Fourier transform of the plurality of initial values to produce a plurality of Fourier coefficients of the plurality of parameters; and (C)(2) means for adjusting the plurality of Fourier coefficients of the plurality of parameters to produce the plurality of adjusted values.

Generating the description of the parametrized circuit may include converting the description of the quantum circuit into the description of the parametrized circuit.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

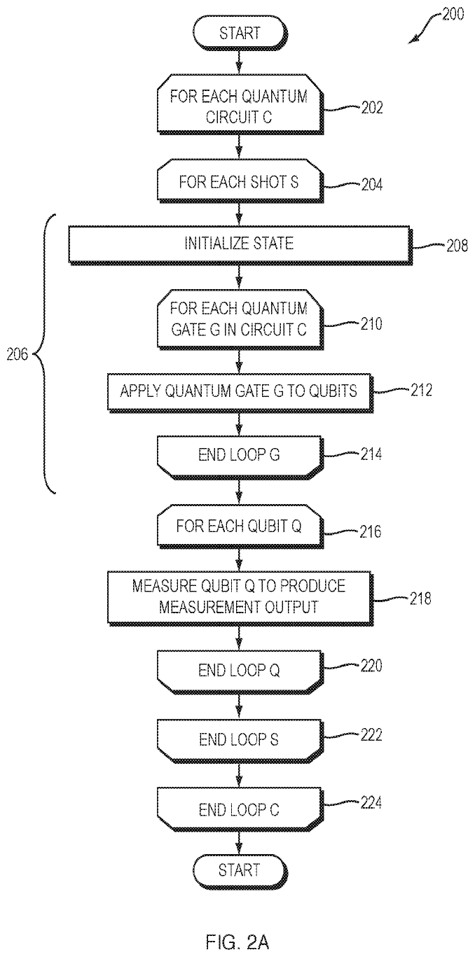

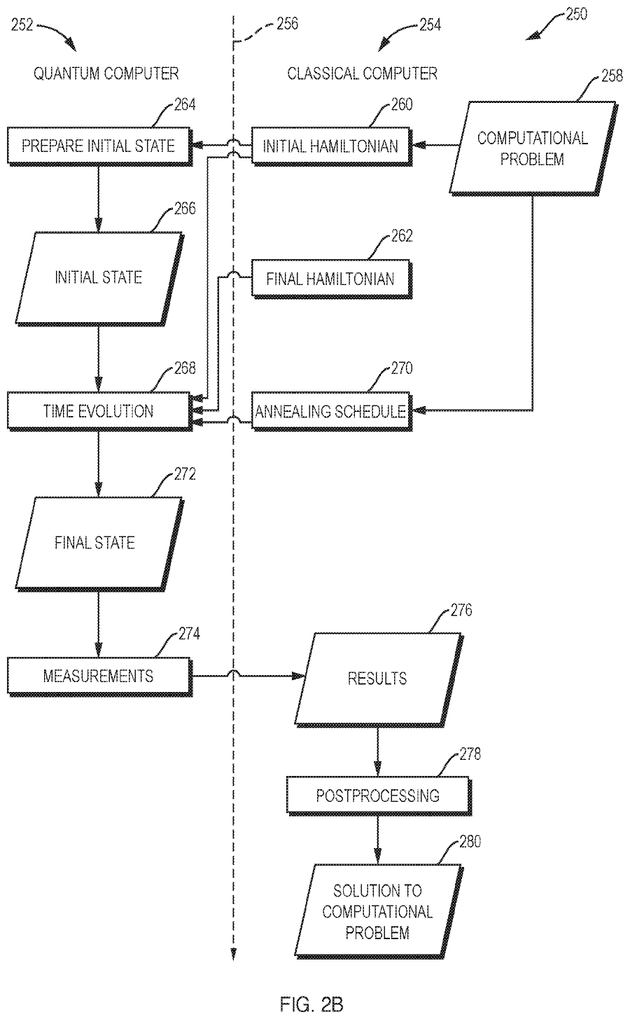

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrodinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

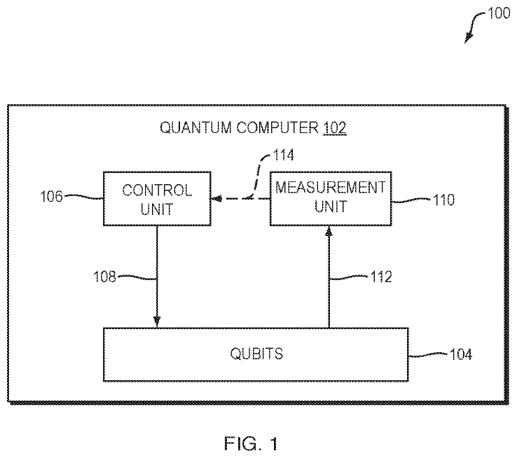

The final state 272 of the quantum computer 254 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 104. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

Referring to FIG. 3, a diagram is shown of a hybrid classical quantum computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals Y32 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals Y34 to the quantum computer 102, in response to which the quantum computer 102 may apply the gate operations specified by the control signals Y32 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output Y38 representing the collapse of the states of the qubits 104 into one of their eigenstates. As a result, the measurement output Y38 includes or consists of bits and therefore represents a classical state. The quantum computer 102 provides the measurement output Y38 to the classical processor 308. The classical processor 308 may store data representing the measurement output Y38 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid classical quantum (HQC) computer. The techniques disclosed herein may, for example, be implemented solely on a classical computer, in which the classical computer emulates the quantum computer functions disclosed herein.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, the size of a classical description of a quantum state grows exponentially in the size of the quantum state, and is thus infeasible to manually perform operations on.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

1. A method of executing quantum computation on a hybrid quantum-classical computer, the hybrid quantum-classical computer comprising a classical computer and a quantum computer, the method comprising:
(A) on the classical computer, converting a description of a first quantum circuit to a description of a target state of a physical system;
(B) on the classical computer, generating a description of a parametrized circuit having a plurality of parameters with a plurality of initial values;
(C) on the hybrid quantum-classical computer, adjusting the plurality of initial values to produce a plurality of adjusted values in an adjusted quantum circuit, the adjusted quantum circuit being adapted to produce a quantum evolution to a state approximating the target state of the physical system.

2. The method of claim 1, wherein (C) comprises performing the adjusting on the classical computer.

3. The method of claim 1, wherein (C) comprises performing the adjusting on the quantum computer.

4. The method of claim 1, further comprising:
(D) on the quantum computer, executing the adjusted quantum circuit to produce the quantum evolution to the state approximating the target state of the physical system.

5. The method of claim 1, wherein the adjusted quantum circuit is adapted to produce a quantum evolution to the target state of the physical system.

6. The method of claim 4, further comprising:
(E) on the quantum computer, executing the adjusted quantum circuit to produce the quantum evolution to the target state of the physical system.

7. The method of claim 1, wherein adjusting the initial values of the plurality of parameters to produce a quantum evolution comprises optimizing the plurality of parameters of the parametrized circuit with respect to an objective function, the optimizing comprising:
(C)(1) executing the parametrized circuit on the quantum computer;
(C)(2) collecting measurement outcomes, resulting from executing the parametrized circuit, on the quantum computer;
(C)(3) estimating the objective function on the classical computer using the measurement outcomes to produce an objective function estimate; and
(C)(4) adjusting the plurality of initial values based on the objective function estimate.

8. The method of claim 7, further comprising repeating (C)(1)-(C)(4) until the adjusted quantum circuit is adapted to produce the quantum evolution to the state approximating the target state of the physical system.

9. The method of claim 1, wherein the physical system comprises interacting spins occupying a two-dimensional lattice.

10. The method of claim 1, wherein the quantum evolution comprises an adiabatic evolution, and wherein converting the description of the quantum circuit to the description of a parametrized circuit comprises:
(B)(1) discretizing the adiabatic evolution into a plurality of segments of evolution under time-independent interactions; and
(B)(2) defining a duration of each of the plurality of time segments as a corresponding one of the plurality of parameters, thereby defining the plurality of parameters.

11. The method of claim 1, wherein adjusting the plurality of initial values comprises:
(C)(1) taking a discrete Fourier transform of the plurality of initial values to produce a plurality of Fourier coefficients of the plurality of parameters; and
(C)(2) adjusting the plurality of Fourier coefficients of the plurality of parameters to produce the plurality of adjusted values.

12. The method of claim 1, wherein generating the description of the parametrized circuit comprises converting the description of the quantum circuit into the description of the parametrized circuit.

13. A hybrid quantum-classical computer comprising:
a classical computer comprising at least one processor and at least one non-transitory computer-readable medium having computer program instructions stored thereon;
a quantum computer comprising a plurality of qubits;
the computer program instructions being executable by the at least one processor to perform a method, the method comprising:
(A) on the classical computer, converting a description of a first quantum circuit to a description of a target state of a physical system;
(B) on the classical computer, generating a description of a parametrized circuit having a plurality of parameters with a plurality of initial values; and
wherein the hybrid quantum-classical computer further includes:
(C) means for adjusting the plurality of initial values to produce a plurality of adjusted values in an adjusted quantum circuit, the adjusted quantum circuit being adapted to produce a quantum evolution to a state approximating the target state of the physical system.

14. The hybrid quantum-classical computer of claim 13, wherein the classical computer comprises the means for adjusting.

15. The hybrid quantum-classical computer of claim 13, wherein the quantum computer comprises the means for adjusting.

16. The hybrid quantum-classical computer of claim 13, wherein the quantum computer further comprises:
(D) means for executing the adjusted quantum circuit to produce the quantum evolution to the state approximating the target state of the physical system.

17. The hybrid quantum-classical computer of claim 13, wherein the adjusted quantum circuit is adapted to produce a quantum evolution to the target state of the physical system.

18. The hybrid quantum-classical computer of claim 16, wherein the quantum computer further comprises:
(E) means for executing the adjusted quantum circuit to produce the quantum evolution to the target state of the physical system.

19. The hybrid quantum-classical computer of claim 13, wherein the means for adjusting the initial values of the plurality of parameters to produce a quantum evolution comprises means for optimizing the plurality of parameters of the parametrized circuit with respect to an objective function, the means for optimizing comprising:
(C)(1) means for executing the parametrized circuit on the quantum computer;
(C)(2) means for collecting measurement outcomes, resulting from executing the parametrized circuit, on the quantum computer;
(C)(3) means for estimating the objective function on the classical computer using the measurement outcomes to produce an objective function estimate; and
(C)(4) means for adjusting the plurality of initial values based on the objective function estimate.

20. The hybrid quantum-classical computer of claim 19, further comprising means for repeating (C)(1)-(C)(4) until the adjusted quantum circuit is adapted to produce the quantum evolution to the state approximating the target state of the physical system.

21. The hybrid quantum-classical computer of claim 13, wherein the physical system comprises interacting spins occupying a two-dimensional lattice.

22. The hybrid quantum-classical computer of claim 13, wherein the quantum evolution comprises an adiabatic evolution, and wherein converting the description of the quantum circuit to the description of a parametrized circuit comprises:
(B)(1) discretizing the adiabatic evolution into a plurality of segments of evolution under time-independent interactions; and
(B)(2) defining a duration of each of the plurality of time segments as a corresponding one of the plurality of parameters, thereby defining the plurality of parameters.

23. The hybrid quantum-classical computer of claim 13, wherein the means for adjusting the plurality of initial values comprises:
(C)(1) means for taking a discrete Fourier transform of the plurality of initial values to produce a plurality of Fourier coefficients of the plurality of parameters; and
(C)(2) means for adjusting the plurality of Fourier coefficients of the plurality of parameters to produce the plurality of adjusted values.

24. The hybrid quantum-classical computer of claim 13, wherein generating the description of the parametrized circuit comprises converting the description of the quantum circuit into the description of the parametrized circuit.
